(19) United States
(12) Patent Application Publication
(10) Pub. No.: US 2016/0267337 A1
(43) Pub. Date: Sep. 15, 2016

(54) DETECTOR ARRAY FOR VEIN RECOGNITION TECHNOLOGY

(71) Applicant: MERCK PATENT GMBH, Darmstadt (DE)

(72) Inventors: Klaus BOFINGER, Brensbach (DE); Miguel CARRASCO-OROZCO, Winchester (GB); Priti TIWANA, Southampton (GB)

(73) Assignee: Merck Patent GmbH, Darmstadt (DE)

(21) Appl. No.: 15/034,255

(22) PCT Filed: Oct. 7, 2014
(86) PCT No.: PCT/EP2014/002718

§ 371 Date: May 4, 2016

(30) Foreign Application Priority Data
Nov. 5, 2013 (EP) 13005213.7

(51) Int. Cl. G06K 9/00; H01L 51/00; G06F 21/32; H04N 5/33; G06F 21/62; H01L 27/30; H01L 51/42

(52) U.S. Cl. CPC G06K 9/00885; H01L 27/307; H01L 51/0096; H01L 51/4273; H04N 5/33; G06F 21/6218; G06F 21/32; H01G 9/2068

(57) ABSTRACT

Disclosed is a detector array for vein recognition technology, which contains an absorber of radiation, a security system that contains the detector array as well as a method for vein recognition.

### TECHNICAL FIELD

The present invention relates to a detector array for vein recognition technology, said detector array comprising an absorber of radiation. The present invention further relates to a security system comprising said detector array as well as to a method for vein recognition.

### BACKGROUND AND DESCRIPTION OF THE PRIOR ART

Biometric recognition, or simply biometrics, involves the use of distinctive anatomical and behavioral characteristics or identifiers (e.g., finger or palm prints, faces, iris, or voices) for personal identification, and offers higher security and convenience compared to traditional token based method (e.g., keys or ID cards) and knowledge-based methods (e.g., passwords or PINs), since they are difficult to misplace, forge or share.

Within biometrics, finger-vein identification technique has been identified as a potentially much more secure recognition system compared to other biometric traits such as face, iris, finger and palm-prints. This is because finger-vein patterns are hidden beneath the human skin and are impossible to alter or cheat, unlike fingerprint or iris scanning. It is a proven fact that the finger-vein pattern is unique to each human being and can be used for personal verification (see for example T. Yanagawa, S. Aoki, T. Ohyama, Human Finger Vein Images Are Diverse and its Patterns Are Useful for Personal Identification; Kyushu University MHF Preprint Series: Kyushu, Japan, 2007; pp. 1). The vein diameter might change temporally due to fluctuations in weather, physical condition etc, but the vein distribution pattern still remains unique to the person and can be matched with the original pattern stored on a previous day for the same person (see for example N. Miura, A. Nagasaka, T. Miyatake, Extraction of Finger-Vein Patterns Using Maximum Curvature Points in Image Profiles. IEICE Trans. Inform. Syst. 2007, E90-D, p. 1185). In contrast to finger-print detection, finger-vein pattern can still be measured in the case of any external injury to the skin. Finger-vein recognition is a non-invasive and non-contact technique and is therefore more acceptable to users. This technique faces much less psychological resistance as is the case for example for iris scans. Additionally, unlike other biometric identifiers, finger vein patterns can only be identified in a living person. The device needed for vein recognition can be very compact and small compared for example to devices used for palm-based verification.

Some exemplary finger vein detection systems as disclosed in US 2004/0184641, U.S. Pat. No. 7,957,563 B2, U.S. Pat. No. 8,155,402 and U.S. Pat. No. 8,223,199 are shown in FIG. 1. Typically, light in the near-infrared (NIR) region emitted from a light-source, for example a light-emitting diode (LED), is transmitted through the subject's finger. The spatial variation in the transmitted light across the finger is mapped, usually with an image pickup system, such as a camera or an image sensor, having high sensitivity for NIR light. Blood vessels preferentially absorb more NIR light compared to other pigments and tissues in the finger. In the captured image, therefore, veins appear significantly darker as peripheral tissue. A pattern generated by the difference between brightness and darkness forms the blood vessel pattern. Post-processing algorithms are then applied to the captured image in order to remove background noise and to generate a high contrast vein-pattern that can be stored in some database for later retrieval for pattern-matching.

As in other detection techniques, the four main steps are image acquisition, pre-processing, feature extraction and matching. A lot of work has been carried out in the last three areas. The present application is focused on the first area, the image capturing part.

The visible part of the spectrum gets absorbed in various tissue pigments inside the human finger, such as hemoglobin, myoglobin, and melanins. Longer infrared wavelengths are strongly attenuated due to absorption in the water in the tissue. At NIR wavelengths, however, hemoglobin exhibits higher absorbance than other proteins in the tissue. Therefore, NIR light transmission can be used to selectively map the location of hemoglobin, and thus the blood vessel pattern, in the subject's finger. This implies that a good NIR detector is required.

The most popular choice for an NIR detector is an optical imaging system. These are usually built with either CCD (charge-coupled device) or CMOS (complementary metal-oxide-semiconductor) sensors. Both types of sensors perform the same task of converting incident light into electric charge and processing it into electronic signals. In order to make the system more sensitive in the NIR wavelength spectrum, a filter is placed before the imaging pixel matrix which blocks visible light and only allows NIR light to pass. This imaging method imposes severe restrictions on the usage of the apparatus, for example it must be used under well-controlled lighting conditions (such as, indoors), and it requires a very precise positioning of the to-be-scanned object, such as for example a subject's finger.

Failure to satisfy these conditions can result in the leakage of ambient light into the detector, which can have severe negative consequences on image quality. On a sunny cloudless day, the NIR component of ambient light can be much stronger than that of the light source in the vein detection apparatus. If this bright background light streams into the detection system, luminance of some of the pixels that lie outside the finger outline (and thus receive unattenuated light) will be saturated at the maximum level. In the final overall image, there will be localized regions of very high intensity which lie outside the desired target area (features within the finger). The rest of the image will be relatively dark and, therefore, will suffer from poor image contrast. The imaging system is designed to generate an image of a very slight difference between bright light and dark light as a blood-vessel pattern within the finger. The presence of the saturated pixels can, thus, lead to a loss of critical information and the imaging system will be unable to produce a reliable mapping of the blood-vessel distribution.

In addition, some CCD sensors can also suffer from a blooming effect in the presence of bright light, leading to bright vertical streaks in the captured image, again resulting in a severe loss of information.

This is a serious shortcoming in most finger-vein detection techniques described in literature. While there are some patents concerning the use of imaging sensors even if there is some background light leaking into the detector array, this involves complicated run-time optimization of the exposure time, shutter size or auto-gain in the camera to block out “intense” ambient light, while ensuring that sufficient light is still captured from the desired target area. This will require multiple exposures of the finger until an acceptable image has been captured. The computation complexity is also much higher for post-processing the image and matching it with the original finger-vein pattern stored in the database. This leads to an overall increase in the cost of personal verification, in terms of money, energy and time. Our novel approach described below will eliminate this problem and help reduce the operational cost of the apparatus significantly.

### SUMMARY OF THE INVENTION

The present inventors have now surprisingly found that the above disadvantages of the prior art can be remedied by the detector array of the present application.

The present application therefore provides for a detector array for vein pattern recognition, said array comprising an absorber capable of absorbing radiation, wherein the absorber is an organic photovoltaic cell.

Additionally, the present application provides for a security system comprising the above detector array.

The present application also provides for a method for vein pattern recognition comprising the steps of
(a) placing an object comprising veins in proximity of a detector array, said detector array comprising an absorber capable of absorbing radiation;
(b) transmitting radiation through the object comprising veins to said absorber; and
(c) detecting the spatial variation in the transmitted radiation, thereby obtaining a map of the object comprising veins,
   wherein the absorber is an organic photovoltaic cell.

Furthermore, the present application provides for a method for producing the above detector array, said method comprising the steps of
(A) producing an organic photovoltaic sensor; and
(B) integrating said organic photovoltaic sensor into a detector array.

### BRIEF DESCRIPTION OF THE FIGURES

FIG. 1a shows an example of a vein detection system, wherein the light source 3 is above the finger and the imaging system 4 is below the finger.

FIG. 1b shows an example of a vein detection system, wherein the light source 114 is beside the finger and the imaging system 112 is below the finger.

FIG. 1c shows an example of a vein detection system, wherein the light source 3 is to the side of the finger and the imaging system below the finger.

FIG. 1d shows an example of a vein detection system, wherein the light source 72 and the imaging system 32 are below the finger.

FIG. 2 illustrates the operation of an organic photovoltaic sensor at forward bias (high load line), zero-bias (low load line) and at reverse bias (load line with reverse voltage applied).

FIG. 3 is a schematic cross-sectional view of an exemplary organic photovoltaic cell 300.

FIG. 4 shows the current:voltage curve obtained for the sensor device of the example.

### DETAILED DESCRIPTION OF THE INVENTION

For the purposes of the present application the term “near infrared”, which may be abbreviated as “NIR”, is used to denote radiation with a wavelength of from 0.7 μm to 3.0 μm, unless otherwise indicated.

For the purposes of the present application the terms “blood vessel” and “vein” are used synonymously.

For the purposes of the present invention a “photovoltaic sensor” comprises an integral number of photovoltaic cells, which can also be referred to as “pixels”, arranged in a matrix, thereby allowing the mapping of the incident radiation intensity by location in said matrix.

As used herein, the term “polymer” will be understood to mean a molecule of high relative molecular mass, the structure of which essentially comprises the multiple repetition of units derived, actually or conceptually, from molecules of low relative molecular mass (Pure Appl. Chem., 1996, 68, 2291). The term “oligomer” will be understood to mean a molecule of intermediate relative molecular mass, the structure of which essentially comprises a small plurality of units derived, actually or conceptually, from molecules of lower relative molecular mass (Pure Appl. Chem., 1996, 68, 2291). In a preferred meaning as used herein a polymer will be understood to mean a compound having >1, i.e. at least 2 repeat units, preferably 5 repeat units, and an oligomer will be understood to mean a compound with >1 and <10, preferably <5, repeat units.

Further, as used herein, the term “polymer” will be understood to mean a molecule that encompasses a backbone (also referred to as “main chain”) of one or more distinct types of repeat units (the smallest constitutional unit of the molecule) and is inclusive of the commonly known terms “oligomer”, “copolymer”, “homopolymer” and the like. Further, it will be understood that the term polymer is inclusive of, in addition to the polymer itself, residues from initiators, catalysts and other elements attendant to the synthesis of such a polymer, where such residues are understood as not being covalently incorporated thereto. Further, such residues and other elements, while normally removed during post polymerization purification processes, are typically mixed or co-mingled with the polymer such that they generally remain with the polymer when it is transferred between vessels or between solvents or dispersion media.

As used herein, the terms “repeat unit”, “repeating unit” and “monomeric unit” are used interchangeably and will be understood to mean the constitutional repeating unit (CRU), which is the smallest constitutional unit the repetition of which constitutes a regular macromolecule, a regular oligomer molecule, a regular block or a regular chain (Pure Appl. Chem., 1996, 68, 2291). As further used herein, the term “unit” will be understood to mean a structural unit which can be a repeating unit on its own, or can together with other units form a constitutional repeating unit.

As used herein, the term “small molecule” will be understood to mean a monomeric compound which typically does not contain a reactive group by which it can be reacted to form a polymer, and which is designated to be used in monomeric form. In contrast thereto, the term “monomer”, unless stated otherwise, will be understood to mean a monomeric compound that carries one or more reactive functional groups by which it can be reacted to form a polymer.

As used herein, the terms “donor” or “donating” and “acceptor” or “accepting” will be understood to mean an electron donor or electron acceptor, respectively. “Electron donor” will be understood to mean a chemical entity that donates electrons to another compound or another group of atoms of a compound. “Electron acceptor” will be understood to mean a chemical entity that accepts electrons transferred to it from another compound or another group of atoms of a compound. See also International Union of Pure and Applied Chemistry, Compendium of Chemical Technology, Gold Book, Version 2.3.2, 19 Aug. 2012, pages 477 and 480.

As used herein, the term “n-type” or “n-type semiconductor” will be understood to mean an extrinsic semiconductor in which the conduction electron density is in excess of the mobile hole density, and the term “p-type” or “p-type semiconductor” will be understood to mean an extrinsic semiconductor in which mobile hole density is in excess of the conduction electron density (see also, J. Thewlis, Concise Dictionary of Physics, Pergamon Press, Oxford, 1973).

Generally stated the present invention relates to a detector array for vein pattern recognition, said array comprising an absorber. The absorber is capable of absorbing radiation. Said radiation may for example be ambient or emitted by an emitter, if one is present. Thus, a preferred detector array for vein pattern recognition comprises an emitter capable of emitting radiation and an absorber capable of absorbing the radiation emitted by the emitter.

Preferably the absorber used in the present detector array is an organic photovoltaic sensor comprising an integral number of organic photovoltaic cells (“pixels”). The number of organic photovoltaic cells comprized in said organic photovoltaic sensor will depend upon the resolution and quality required for the intended application of said detector array. For example, the organic photovoltaic sensor may have at least 100, at least 1000 or even at least 10,000 organic photovoltaic cells arranged in a matrix. It is clear that for a specified size of detector array an increase in the number of organic photovoltaic cells will result in an increase in resolution and therefore in the quality of the finally obtained data. While the maximum number of organic photovoltaic cells comprized in the organic photovoltaic sensor is not particularly limited, it is nevertheless preferred that the organic photovoltaic sensor comprises at most 1,000,000, more preferably at most 500,000, even more preferably at most 100,000, and most preferably at most 50,000 organic photovoltaic cells.

Each organic photovoltaic cell is capable of converting incident photons, which in the present case may be ambient or—if an emitter is present—originate from the emitter, into electrons, which can then be collected and their number recorded.

The type of radiation used for the present purpose is not very limited provided that it is capable of showing differences between beams passing through a vein and beams not passing through a vein. It is, however, preferred that the radiation used herein has a wavelength in the range from 0.7 μm to 3.0 μm (“NIR”).

The choice of near infrared radiation (NIR) is particularly advantageous. When near infrared radiation is passed through a region of an object which is rich in veins, i.e. blood vessels, the transmitted radiation is strongly attenuated due to absorption by the blood hemoglobin. Consequentially a negligible amount of transmitted radiation arrives at the absorber in this particular spot, meaning that in the corresponding region of the organic photovoltaic sensor a low current is created. In contrast, the larger amounts of radiation transmitted through the peripheral regions, i.e. without blood vessels, will result in higher currents being created in the corresponding regions of the absorber. Organic photovoltaic cells are particularly useful in this application because the short-circuit current generated therein is directly proportional to the light falling thereon. The variations in current from the different regions of the organic photovoltaic sensor can be used to generate a gray-scale image of the blood vessel (vein) pattern. In the captured image, the dark regions will be of particular interest because they represent the blood vessels. Following the determination of the outline of the object using a post-processing algorithm, the regions outside it can be discarded. Then the dark-bright pattern can be generated using a known algorithm as for example disclosed in Yang Jinfeng et al., Scattering removal for finger-vein image restoration, Sensors 12 (3) (2012) p. 3627; in Yun-Xin Wang et al., Proceedings of SPIE (2009), 7512 (Optoelectronic Information Security), 751204/1-751204/8; in CN 101789076 A; in N. Miura et al., Extraction of Finger-Vein Patterns Using Maximum Curvature Points in Image Profiles. IEICE Trans. Inform. Syst. 2007, E90-D, p. 1185; in Jinfeng Yang and Xu Li, 2010 International Conference on Pattern Recognition, p. 1148; in Gongping Yang et al., Finger Vein Recognition Based on a Personalized Best Bit Map, Sensors 2012, 12, 1738-1757; in Yu Cheng-Bo et al., Finger-vein image recognition combining modified Hausdorff distance with minutiae feature matching, Computational life sciences (2009), 1 (4), p. 280; in CN102214297(A); or in KR20110078231(A).

Organic photovoltaic sensors are advantageously used in this application because they also perform well under low light conditions, such as for example under room light or diffuse cloudy (“outside”) conditions (see for example R. Steim et al, Solar Energy Materials & Solar Cells 95 (2011) 3256-3261). In addition organic photovoltaic cells exhibit a linear relationship between short-circuit current and incident light intensity up to at least 1.2 Sun AM1.5G intensity (ca. 120 mW/cm²) (see for example Maurano et al, J. Phys. Chem. C 2011, 115, 5947-5957), corresponding to about 32,000 to 130,000 lx illuminance. By contrast, silicon-based photodiodes generally tend to show a saturation limit at 0.1 to 10 mW/cm², corresponding to about 10⁴ lx, depending upon the reverse bias conditions, thus showing the need to minimize the amount of background light entering the detection chamber during image acquisition.

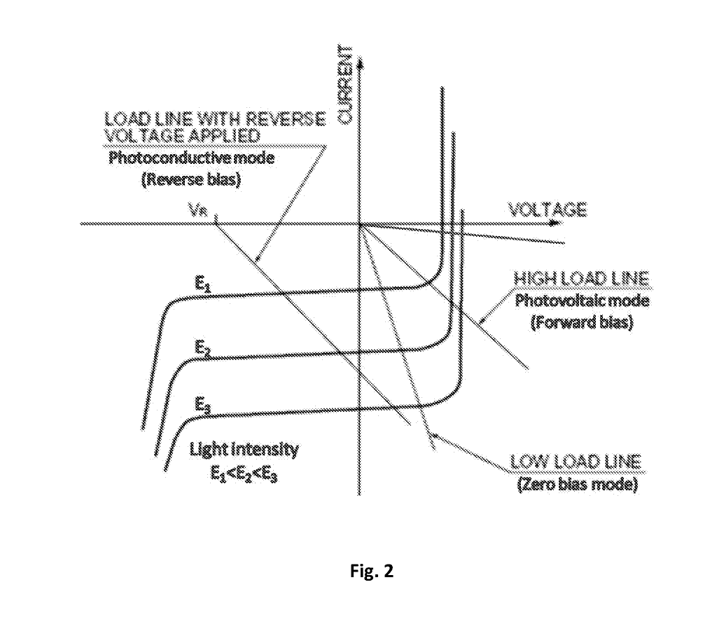

Organic photovoltaic sensors can be employed as photodiodes in forward bias mode, at zero bias, and in reverse bias, as is illustrated in FIG. 2. This also allows for easy adaptation to the performance required of the detector array in a specific location. When operated in the photoconductive mode (3rd quadrant, reverse bias), the output current is linearly proportional to illumination intensity for a wide range of load resistances. While this design benefits from a high speed response, it suffers from increased noise due to increased dark (leakage) current. In case of operation at zero bias (low load line), the voltage is linearly dependent on the incident illumination and has low noise due to almost complete elimination of leakage current. Finally, the dark current is also minimal in case of operation in the photovoltaic mode (4th quadrant, high load line, forward bias), and the photo-generated voltage is a logarithmic function of incident light intensity. Depending on the bias condition, it is therefore possible to measure either the short-circuit current or the voltage directly from the organic photovoltaic sensors. This reduces the complexity of electronics required for data acquisition. In addition to saving material and manufacturing cost, this implies that the overall absorber area is composed predominantly of organic photovoltaic cells (“pixels”) with minimal space lost to electronics, thus offering better image capturing. Ultimately, the final choice of operating bias depends on the final implementation of the sensor in the vein detection apparatus.

In contrast to conventional imaging systems, a vein recognition apparatus using an organic photovoltaic sensor can, therefore, be used in indoor or outdoor conditions. The background ambient light can also be used to supplement the light source. The power supplied to the light source can be reduced or even switched off in the presence of sufficient background light, thus making it an energy-saving “green” technology. In comparison to silicon photodiodes organic photovoltaic sensors offer the additional advantage of having only a negligible dependence of performance characteristics on the operating temperature. This temperature dependence is the reason why silicon photodiodes are only rarely operated in the photovoltaic mode. This enables reliable image acquisition under a range of environmental conditions using an OPV sensor.

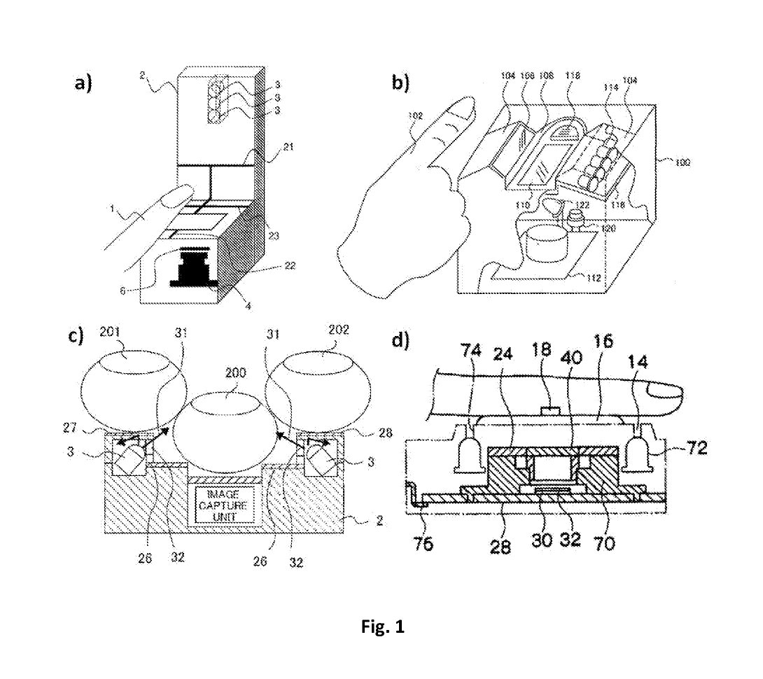

The present detector array also allows high flexibility in respect to the relative positioning of emitter (if present), absorber and the object comprising veins, which is to be scanned. As illustrated in FIGS. 1a to 1d the light source can be placed above, besides or below the object and the radiation absorber. In each case, the imaging system will capture the object's vein pattern with high contrast and signal-to-noise ratio. The light source can be placed at a range of angles and distances from the detector array. Since organic photovoltaic cells have been shown to work well under diffuse and oblique light, their performance will not be significantly altered. Positioning the light source directly above the organic photovoltaic sensors and placing the object to be scanned between emitter and absorber is, however, recommended because the transmitted light reaching the absorber will be significantly less scattered by the tissue in the scanned object if the light is normally incident on the scanned object. This reduces the post-processing effort required for generating the final high contrast image. However, in some instances it may be advantageous to place the sensor at some distance and angle away from the detector, depending on the end-product. The organic photovoltaic sensor will show good results in either case.

Additionally, organic photovoltaic sensors and cells offer the advantage that material as well as production cost are lower as compared to silicon-based sensors. It has been shown that a complete organic photovoltaic cell stack is solution-processable and can be printed on large-area sheets in a roll-to-roll process (see for example F. C. Krebs et al, J. Mater. Chem., 2009, 19, 5442-5451; and F. C. Krebs et al, Solar Energy Materials & Solar Cells 93 (2009) 394-412).

The type of organic photovoltaic cell used in the present organic photovoltaic sensor is not particularly limited and may for example be based on polymers or small molecules or both. It is also possible to use dye-sensitized solar cells (DSSCs). While the structure of the organic photovoltaic cell and the organic photovoltaic sensor may differ, the overall function and advantageous features described above are applicable to each case.

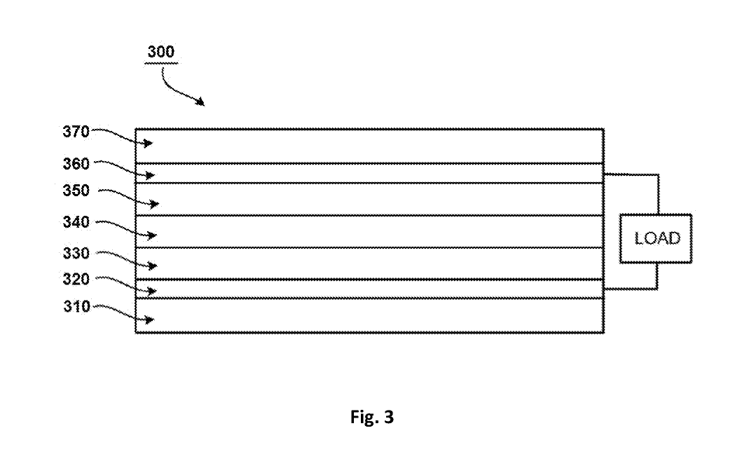

FIG. 3 shows a cross-sectional view of an exemplary organic photovoltaic cell 300 that includes an optional substrate 310, an electrode 320, a hole transport (or electron blocking) layer 330, a photoactive layer 340 (e.g. containing an electron acceptor material and an electron donor material), an electron carrier (or hole blocking) layer 350, an electrode 360, and an optional substrate 370. Alternately, layer 330 can be an electron transport (or hole blocking) layer and layer 350 can be a hole transport (or electron blocking) layer. The overall stack may be encapsulated within a flexible or rigid casing.

In general, during use, light can impinge on the surface of substrate 310, and passes through substrate 310, electrode 320 and hole (or electron) transport layer 330. The light then interacts with the photoactive layer 340, causing electrons to be transferred from the electron donor material (e.g. a conjugated polymer) to the electron acceptor material (e.g. a substituted fullerene). The electron acceptor material then transmits the electrons through electron transport layer 350 (or 330) to electrode 360 (or 320), and the electron donor material transfers holes through hole carrier layer 330 (or 350) to electrode 320 (or 360). Electrodes 320 and 360 are in electrical connection via an external load so that electrons pass from electrode 320 through the load to electrode 360.

If present, substrate 310 may for example be formed of a transparent material. As referred to herein, a transparent material is a material which, at the thickness generally used in a photovoltaic cell 300, transmits at least about 60% (e.g., at least about 70%, at least about 75%, at least about 80%, at least about 85%) of incident light at a wavelength or a range of wavelengths used during operation of the photovoltaic cell. Exemplary materials from which substrate 310 can be formed include glass, polyethylene terephthalates, polyimides, polyethylene naphthalates, polymeric hydrocarbons, cellulosic polymers, polycarbonates, polyamides, polyethers, and polyether ketones. In certain embodiments, the polymer can be a fluorinated polymer. In some embodiments, combinations of polymeric materials are used. In certain embodiments, different regions of substrate 310 can be formed of different materials.

If present, substrate 310 may also be a non-transparent material. Exemplary non-transparent materials are metal foils, such as for example steel foil or aluminum foil.

In general, substrate 310 can be flexible, semi-rigid or rigid (e.g., glass). In some embodiments, substrate 310 has a flexural modulus of less than about 5,000 mPa (e.g., less than about 1,000 mPa or less than about 500 mPa). In certain embodiments, different regions of substrate 310 can be flexible, semi-rigid, or inflexible (e.g., one or more regions flexible and one or more different regions semi-rigid, one or more regions flexible and one or more different regions inflexible).

Typically, substrate 310 has a thickness at least about one micron (e.g., at least about five microns or at least about 10 microns) and/or at most about 5,000 microns (e.g., at most about 2,000 microns, at most about 1,000 microns, at most about 500 microns, at most about 300 microns, at most about 200 microns, at most about 100 microns, or at most about 50 microns).

Generally, substrate 310 can be colored or non-colored. In some embodiments, one or more portions of substrate 310 is/are colored while one or more different portions of substrate 310 is/are non-colored.

Substrate 310 can have one planar surface (e.g., the surface on which light impinges), two planar surfaces (e.g., the surface on which light impinges and the opposite surface), or no planar surface. A non-planar surface of substrate 310 can, for example, be curved or stepped. In some embodiments, a non-planar surface of substrate 310 is patterned (e.g., having patterned steps to form a Fresnel lens, a lenticular lens or a lenticular prism).

Electrode 320 is generally formed of an electrically conductive material. Exemplary electrically conductive materials include electrically conductive metals, electrically conductive alloys, electrically conductive polymers, electrically conductive metal oxides, and any combinations of these. Exemplary electrically conductive metals include gold, silver, copper, aluminum, nickel, palladium, platinum, and titanium. Exemplary electrically conductive alloys include stainless steel (e.g., 332 stainless steel, 316 stainless steel), alloys of gold, alloys of silver, alloys of copper, alloys of aluminum, alloys of nickel, alloys of palladium, alloys of platinum, and alloys of titanium. Exemplary electrically conducting polymers include polythiophenes (e.g., doped poly(3,4-ethylenedioxythiophene) (doped PEDOT)), polyanilines (e.g., doped polyanilines), polypyrroles (e.g., doped polypyrroles). Exemplary electrically conducting metal oxides include indium tin oxide, fluorinated tin oxide, tin oxide and zinc oxide. In some embodiments, combinations of electrically conductive materials are used.

In some embodiments, electrode 320 can include a mesh electrode. Examples of mesh electrodes are described in U.S. Patent Application Publications Nos. 2004-0187911 and 2006-0090791.

In some embodiments, any combination of the electrically conductive materials described above can be used to form electrode 320.

Further preferably the OPV or organic photodetector (OPD) device comprises, between the active layer and the first or second electrode, one or more additional buffer layers acting as hole transporting layer and/or electron blocking layer 330, which comprise a material such as metal oxide, like for example, zinc tin oxide (ZTO), MoOₓ, NiOₓ, a conjugated polymer electrolyte, like for example PEDOT:PSS, a conjugated polymer, like for example polytriarylamine (PTAA), an organic compound, like for example N,N′-diphenyl-N,N′-bis(1-naphthyl)(1,1′-biphenyl)-4,4′diamine (NPB), N,N′-diphenyl-N,N′-(3-methylphenyl)-1,1′-biphenyl-4,4′-diamine (TPD), or alternatively as hole blocking layer and/or electron transporting layer, which comprise a material such as metal oxide, like for example, ZnOₓ, TiOₓ, a salt, like for example LiF, NaF, CsF, a conjugated polymer electrolyte, like for example poly[3-(6-trimethylammoniumhexyl)thiophene], poly (9,9-bis(2-ethylhexyl)-fluorene]-b-poly[3-(6-trimethylammoniumhexyl)thiophene], or poly [(9,9-bis(3′-(N,N-dimethylamino)propyl)-2,7-fluorene)-alt-2,7-(9,9-dioctylfluorene)] or an organic compound, like for example tris(8-quinolinolato)-aluminium(III) (Alq₃), 4,7-diphenyl-1,10-phenanthroline.

Photoactive layer 340 generally comprises an electron acceptor material and an electron donor material. The electron donor and acceptor materials may also be present in the form of a controlled microstructure such as nanotubes, nanowires, or self-assembled interconnected networks. Additionally the photoactive layer 340 may also comprise further components, such as for example any one or more selected from the group consisting of radical scavengers, anti-oxidants, getters/dessicants, and UV absorbers. Alternatively, photoactive layer 340 may comprise the electron acceptor material and the electron donor material in respective separate layers, i.e. the photoactive layer 340 comprises two adjacent layers, one of which essentially consists of an electron donor material and the other essentially consists of an electron acceptor material.

Examples of electron acceptor materials may be selected from the group consisting of metal oxides, graphene, fullerenes, inorganic nanoparticles, oxadiazoles, discotic liquid crystals, carbon nanorods, inorganic nanorods, polymers containing moieties capable of accepting electrons or forming stable anions (e.g., polymers containing CN groups or polymers containing CF₃ groups), and any combinations thereof. In some embodiments, the electron acceptor material may be a substituted fullerene (e.g., an indene-C₆₀-fullerene bisaduct, or a (6,6)-phenyl-butyric acid methyl ester derivatized methano C₆₀ fullerene, also known as “PCBM-C₆₀” or “C₆₀PCBM”, as disclosed for example in G. Yu et al., Science 1995, Vol. 270, p. 1789 ff and having the structure shown below, or structural analogous compounds with e.g. a C₆₁ fullerene group, a C₇₀ fullerene group, or a C₇₁ fullerene group, or an organic polymer (see for example K. M. Coakley and M. D. McGehee, Chem. Mater. 2004, 16, 4533). Suitable metal oxides may for example be selected from the list consisting of zinc oxide (ZnOₓ), zinc tin oxide (ZTO), titan oxide (TiOₓ), molybdenum oxide (MoOₓ), nickel oxide (NiOₓ), cadmium selenide (CdSe) or cadmium sulfide (CdS), In some embodiments, a combination of electron acceptor materials can be used in photoactive layer 340.

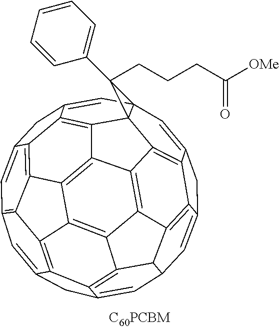 [SMILES: COC(=O)CCCC1(c2ccccc2)C23C=C4CC5=CC6C=C7Cc8cc9cc%10c%11c(c%12c%13c%14c(c4c5c4c%14c5c(c7c8c7c9c%11c%13c57)C46)C%1221)C(=C3)C%10]

Preferably the electron acceptor material is selected from the group consisting of fullerenes or substituted fullerenes, like for example PCBM-C₆₀, PCBM-C₇₀, PCBM-C₆₁, PCBM-C₇₁, bis-PCBM-C₆₁, bis-PCBM-C₇₁, ICMA-c₆₀ (1′,4′-Dihydro-naphtho[2′,3′:1,2][5,6]fullerene-C₆₀), ICBA-C₆₀, oQDM-C₆₀ (1′,4-dihydro-naphtho[2′,3′:1,9][5,6]fullerene-C₆₀-lh), bis-oQDM-C₆₀, graphene, or a metal oxide, like for example, ZnOₓ, TiOₓ, ZTO, MoOₓ, NiOₓ, or quantum dots like for example CdSe or CdS.

Examples of electron donor materials may be selected from the group consisting of polymers, metal oxides, metal oxides comprising a dopant and combinations thereof. Examples of suitable polymers are conjugated polymers, such as polythiophenes, polyanilines, polycarbazoles, polyvinylcarbazoles, polyphenylenes, polyphenylvinylenes, polysilanes, polythienylenevinylenes, polyisothianaphthanenes, polycyclopentadithiophenes, polysilacyclopentadithiophenes, polycyclopentadithiazoles, polythiazolothiazoles, polythiazoles, polybenzothiadiazoles, poly(thiophene oxide)s, poly(cyclopentadithiophene oxide)s, polythiadiazoloquinoxalines, polybenzoisothiazoles, polybenzothiazoles, polythienothiophenes, poly(thienothiophene oxide)s, polydithienothiophenes, poly(dithienothiophene oxide)s, polyfluorenes, polytetrahydroisoindoles, and copolymers thereof. In some embodiments, the electron donor material can be selected from the group consisting of polythiophenes (e.g., poly(3-hexylthiophene)), polycyclopentadithiophenes, and copolymers thereof. Examples of suitable metal oxides include copper oxides, strontium copper oxides and strontium titanium oxides, or a metal oxide comprising a dopant. Examples thereof include p-doped zinc oxides or p-doped titanium oxides. Examples of useful dopants include salts or acids of fluoride, chloride, bromide and iodide. In certain embodiments, a combination of electron donor materials can be used in photoactive layer 340.

Examples of other polymers suitable for use in photoactive layer 340 have been described for example in U.S. Pat. Nos. 7,781,673 and 7,772,485, PCT Application No. PCT/US2011/020227, and U.S. Application Publication Nos. 2010-0224252, 2010-0032018, 2008-0121281, 2008-0087324, 2007-0020526, and 2007-0017571.

Alternatively, for small molecule-based organic photovoltaic sensors the polymer-based bulk heterojunction (BHJ) (or photoactive) layer 340 is replaced with a co-evaporated or solution processed layer of a small molecule donor (such as for example a metal-phthalocyanine, e.g. CuPc, ZnPc or SubPc) and a small molecule acceptor, such as PC₆₁BM, while the remaining layers may be the same as described above.

Optionally, photovoltaic cell 300 can include a hole blocking layer 350. The hole blocking layer is generally formed of a material that, at the thickness generally used in photovoltaic cell 300, transports electrons to electrode 360 and substantially blocks the transport of holes to electrode 360. Examples of materials from which the hole blocking layer can be formed include LiF, metal oxides (e.g., zinc oxide or titanium oxide), and amines (e.g., primary, secondary, or tertiary amines). Examples of amines suitable for use in a hole blocking layer have been described, for example, in U.S. Application Publication No. 2008-0264488, now U.S. Pat. No. 8,242,356.

Without wishing to be bound by theory, it is believed that, when photovoltaic cell 300 includes a hole blocking layer made of amines, the hole blocking layer can facilitate the formation of ohmic contact between photoactive layer 340 and electrode 360 without being exposed to UV light, thereby reducing damage to photovoltaic cell 300 resulting from UV exposure.

In some embodiments, hole blocking layer 350 can have a thickness of at least about 1 nm (e.g., at least about 2 nm, at least about 5 nm, or at least about 10 nm) and/or at most about 50 nm (e.g., at most about 40 nm, at most about 30 nm, at most about 20 nm, or at most about 10 nm).

Electrode 360 is generally formed of an electrically conductive material, such as one or more of the electrically conductive materials described above with respect to electrode 320. In some embodiments, electrode 360 is formed of a combination of electrically conductive materials. In certain embodiments, electrode 360 can be formed of a mesh electrode. Preferably, electrode 360 is formed of silver.

Substrate 370 can be identical to or different from substrate 310. In some embodiments, substrate 370 can be formed of glass or one or more suitable polymers, such as the polymers used in substrate 310 described above.

While certain embodiments have been disclosed, other embodiments are also possible.

In some embodiments, photovoltaic cell 300 includes a cathode as a bottom electrode (i.e. electrode 320) and an anode as a top electrode (i.e. electrode 360). In some embodiments, photovoltaic cell 300 can include an anode as a bottom electrode and a cathode as a top electrode.

In some embodiments, one of substrates 310 and 370 can be transparent. In other embodiments, both of substrates 310 and 370 can be transparent.

In some embodiments, the above disclosed hole carrier layer can also be used in a system in which two photovoltaic cells share a common electrode. Such a system is also known as tandem photovoltaic cell. Exemplary tandem photovoltaic cells have been described in, e.g., U.S. Application Publication Nos. 2009-0211633, 2007-0181179, 2007-0246094, and 2007-0272296.

While the above refers to the exemplary organic photovoltaic cell as schematically illustrated in FIG. 3, it is clear that the above applies equally well to organic photovoltaic cells with a different sequence in layers than the one shown in FIG. 3.

A general description of suitable organic photovoltaic cells can for example also be found in Waldauf et al., Appl. Phys. Lett., 2006, 89, 233517.

The methods of preparing each of layers 320, 330, 340, and 360 in photovoltaic cell 300 can vary as desired, depending for example on the application, required resolution and manufacturing costs. In some embodiments, layers 320, 330, 340, or 360 can be prepared by a gas phase based coating process or a liquid-based coating process, chosen for example from a range of well-known printing techniques, such as for example screen-printing or ink-jet printing. Liquid (solution) coating of devices is more desirable than vacuum deposition techniques. Solution deposition methods are especially preferred. Preferred deposition techniques include, without limitation, dip coating, spin coating, ink jet printing, nozzle printing, letter-press printing, screen printing, gravure printing, doctor blade coating, roller printing, reverse-roller printing, offset lithography printing, dry offset lithography printing, flexographic printing, web printing, spray coating, curtain coating, brush coating, slot dye coating or pad printing. For the fabrication of OPV devices and modules area printing method compatible with flexible substrates are preferred, for example slot dye coating, spray coating and the like.

Ink jet printing is particularly preferred when high resolution layers and devices need to be prepared. Selected formulations of the present invention may be applied to prefabricated device substrates by ink jet printing or microdispensing. Preferably industrial piezoelectric print heads such as but not limited to those supplied by Aprion, Hitachi-Koki, InkJet Technology, On Target Technology, Picojet, Spectra, Trident, Xaar may be used to apply the organic semiconductor layer to a substrate. Additionally semi-industrial heads such as those manufactured by Brother, Epson, Konica, Seiko Instruments Toshiba TEC or single nozzle microdispensers such as those produced by Microdrop and Microfab may be used.

In some embodiments, when a layer (e.g., layer 320, 330, 340, or 360) includes inorganic semiconductor material, the liquid-based coating process can be carried out by (1) mixing the inorganic semiconductor material with a solvent (e.g., an aqueous solvent or an anhydrous alcohol) to form a dispersion, (2) coating the dispersion onto a substrate, and (3) drying the coated dispersion.

In general, the liquid-based coating process used to prepare a layer (e.g., layer 320, 330, 340, or 360) containing an organic semiconductor material can be the same as or different from that used to prepare a layer containing an inorganic semiconductor material. In some embodiments, to prepare a layer including an organic semiconductor material, the liquid-based coating process can be carried out by mixing the organic semiconductor material with a solvent (e.g., an organic solvent) to form a solution or a dispersion, coating the solution or dispersion on a substrate, and drying the coated solution or dispersion.

In some embodiments, photovoltaic cell 300 can be prepared in a continuous manufacturing process, such as a roll-to-roll process, thereby significantly reducing the manufacturing cost. Examples of roll-to-roll processes have been described in, for example, commonly-owned U.S. Pat. Nos. 7,476,278 and 8,129,616.

The fabrication of an organic photovoltaic cell 300 can proceed for example as follows:

The substrate may be a flexible substrate (such as PEN, PET) or a rigid substrate such as glass. A transparent electrode 320 may be applied to this substrate. Typically this may be achieved by sputtering a layer of indium tin-oxide (ITO) or fluorine-doped tin-oxide (FTO) providing an acceptable conductivity. In one embodiment, a hole-transporting layer (HTL), such as for example PEDOT:PSS, may be applied on the conducting substrate, for example by spin-coating, doctor-blade coating, evaporating or printing. A formulation comprising an organic donor material, such as P3HT, and an organic acceptor material, such as PC₆₁BM, in a halogenated or non-halogenated solvent may then be applied using a preferred coating method, optionally followed by an annealing step, thereby forming a randomly organized bulk heterojunction (BHJ) layer. Preferably the optional annealing step is performed at a temperature higher than ambient temperature. This may be followed by the deposition of an electron transporting layer (ETL), such as Ca or LiF, coated via evaporation or solution-based processing. Finally, the device may be completed by depositing a metal electrode on top, for example by evaporation through a shadow-mask or by printing.

In the production of dye-sensitized solar cells (DSSCs) a paste of a semiconducting metal oxide, such as TiO₂, SnO₂ or ZnO, may be applied on the transparent conducting oxide, such as fluorine-doped tin-oxide (FTO). This may for example be done using any well-known printing technique, such as screen-printing, roll-to-roll coating, etc. The metal oxide may then be sensitized with a light absorbing dye. A popularly used dye is ruthenium-based N3 dye (cis-bis(iso-thiocyanato)-bis(2,2 [symbol] -bipyridyl-4,4 [symbol] -di-carboxylato) ruthenium(II)). Alternatively, the place of the dye may be taken by perovskites, for example by organometal trihalide perovskites of general formula (RNH₃)BX₃ with R being CₙH₂ₙ₊₁; X being I, Br or Cl; and B being Pb or Sn. Such perovskites have for example been disclosed by M. Liu et al. in Nature, 19 Sep. 2013, Vol. 501, pages 395-398. Following this, a hole transporting material (HTM) (e.g. 2,2′,7,7′-tetrakis-(N,N-di-p-methoxyphenylamine)9,9′-spiro-bifluorene, which may also be referred to as Spiro-OMeTAD) or an electrolyte (e.g. I⁻/I₃⁻ redox couple) may be coated onto the substrate. Finally, a metal electrode may be coated on top, via evaporation or printing. The HTM or electrolyte can be applied either before coating the metal electrode, or after the evaporation, using vacuum-based back-filling.

The method by which the organic photovoltaic cell is integrated into the detector array is not particularly limited and can be any of the ones commonly employed. For example the organic photovoltaic cell can be fabricated separately, including steps comprising lamination and/or encapsulation, and subsequently the electronic components may be overlaid so that the connections with individual pixels are achieved. Alternatively, the electronic components may be applied directly, for example by coating, printing or any other suitable method after deposition of the top electrode.

Organic photovoltaic sensors are also much thinner than conventional silicon systems. All these are extremely desirable features when incorporating biometric detection schemes in mobile handheld devices such as mobile phones or PDAs (personal digital assistants).

In some embodiments the present detector array is comprized in a security system. For example, the security system may be an access control system. The term “access control” is used in a very broad sense and may apply to any situation where “controlled access” needs to be given. This may for example be the case for access to restricted areas, such as work places or private residences, but also to bank accounts or computer networks, to name a few examples only.

The presently disclosed detector array is particularly well-suited for the recognition of vein patterns. Hence, the present application also relates to the use of or a method of using the above defined detector array in vein pattern recognition.

According to the present invention, an object comprising veins is placed in proximity of a detector array comprising an absorber as defined above. Radiation is then transmitted through the object comprising veins to the absorber. In case an emitter is present, an object comprising veins is placed in proximity of a detector array comprising an emitter and an absorber as defined above, and radiation is then transmitted from the emitter through the object comprising veins to the absorber. In the absorber each separate organic photovoltaic cell (“pixel”) creates a current that is proportional to the incident light intensity, thereby allowing the detection of the spatial variation in the transmitted radiation, which can in turn be used to obtain a map of the object comprising veins. Preferably, in a subsequent step, well-known algorithms are used to generate from said map a vein pattern. Optionally, this vein pattern can then be checked against a library of vein patterns. In case a positive match is found, an action may result, such as for example giving access to a restricted area or to a computer terminal.

Thus, in general form the present method for vein pattern recognition comprises the steps of (a) placing a to-be-scanned object in proximity of a detector array, (b) transmitting radiation through said object, and (c) detecting the incoming radiation intensity in dependence of the respective location in the scanned area.

Preferably, step (a) of said method comprises the step of placing an object comprising veins in proximity of a detector array as defined earlier in this application.

Preferably, step (b) of said method comprises the step of transmitting radiation from an emitter through the object comprising veins to an absorber. It is noted that for the purposes of the present application the term “transmitting radiation” is meant to include that ambient radiation passes through said object.

Preferably, step (c) of said method comprises the step of detecting the spatial variation in the transmitted radiation, thereby obtaining a map of the object comprising veins.

Optionally, said method may comprise further step (d) of generating from said map obtained in step (c) a vein pattern.

Unless the context clearly indicates otherwise, as used herein plural forms of the terms herein are to be construed as including the singular form and vice versa.

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination.

Likewise, features described in non-essential combinations may be used separately (not in combination).

### EXAMPLE

The following example illustrates the advantages of the present invention in a non-limiting way.

A simple sensor device was fabricated using an organic photovoltaic cell 300 as illustrated in FIG. 3. Onto a glass substrate 370 with a transparent conducting indium tin oxide (ITO) film as top electrode 360 was spin-coated a caesium carbonate-based electron transport layer 350 having a thickness of 40 nm. Then a photoactive layer 340 was deposited onto the electron transport layer 350. Said photoactive layer comprised a blend of a photoactive polymer absorbing in the visible and NIR regions, said polymer being a copolymer primarily comprising benzodithiophene and 2,1,3-benzothiadiazole units, and PCBM-C71 in a weight ratio of 1:1.5. Then an electron blocking layer 330 being less than 10 nm thick was spin-coated onto the photoactive layer. The bottom electrode 320 was formed by a 10 nm thick layer of silver. Performance was determined on the device without any encapsulation.

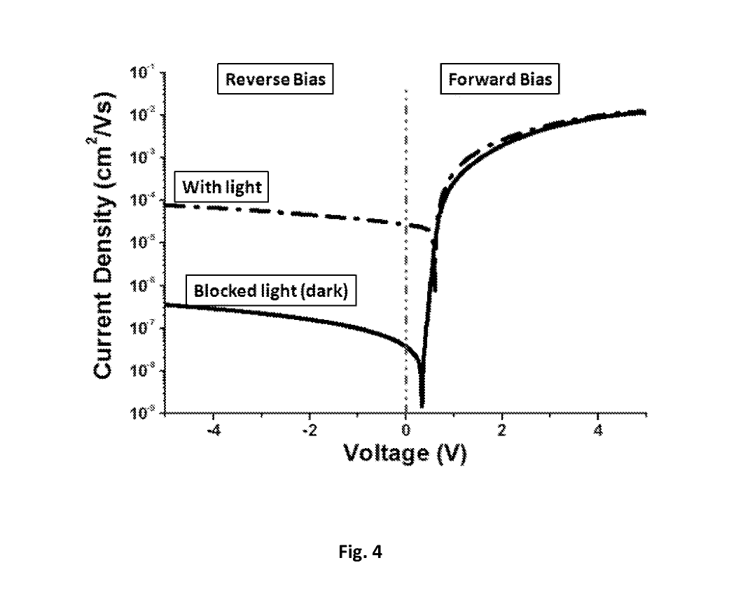

The current:voltage characteristics were measured by shining a low intensity light from an LED at 950 nm, incident from the ITO/glass side of the device. The voltage was scanned between −5 V and +5V, and the resulting current was measured using a Keithley source meter unit (SMU). The respective curves are shown in FIG. 4, with the solid line being taken under dark conditions and the dash-dot line being taken under light conditions. The results clearly show that the light/dark sensitivity is of more than 2 orders of magnitude, which is considered sufficient for practical use.

The present example clearly shows the workability of an organic photovoltaic sensor as an effective image capturing device for a vein detection system. In the instance when a finger is placed between the light source, which can for example be artificial or natural light, and the sensor, the NIR part of the light will get absorbed by any blood carrying veins. As a result, no NIR light will arrive at the sensor and the resulting sensor response is that of the solid black line in FIG. 4, labeled “blocked light (dark)”. In contrast, any light passing through regions of the finger without veins will allow the NIR light to reach the sensor, with the resulting curve shown as dash-dot line in FIG. 4, labeled “with light”. The difference between the response “with light” and the response “blocked light (dark)” is sufficient to generate a light and dark image map, corresponding to the absence or presence of a vein respectively. It is noted that the results shown in FIG. 4 were obtained for an organic photovoltaic sensor with a single organic photovoltaic cell. However, this can easily be applied to create a two-dimensional array of organic photodetector pixels, which will allow accurately creating an image of the vein pattern in any part of, for example the human body, particularly for example a hand, that is placed between the light source and the sensor array.

1. A detector array for vein pattern recognition, said array comprising an absorber capable of absorbing radiation, wherein the absorber is an organic photovoltaic sensor comprising an integral number of organic photovoltaic cells.

2. The detector array according to claim 1, wherein the radiation has a wavelength in the range from 0.7 μm to 3.0 μm.

3. The detector array according to claim 1, wherein the organic photovoltaic sensor comprises at least 100 organic photovoltaic cells.

4. The detector array according to claim 1, wherein each organic photovoltaic cell comprises a photoactive layer.

5. The detector array according to claim 1, wherein each organic photovoltaic cell comprises a photoactive layer, said photoactive layer comprising an electron acceptor material and an electron donor material.

6. The detector array according to claim 1, wherein each organic photovoltaic cell comprises a photoactive layer, said photoactive layer comprising an electron acceptor material selected from the group consisting of metal oxides, graphene, fullerenes, inorganic nanoparticles, oxadiazoles, discotic liquid crystals, carbon nanorods, inorganic nanorods, polymers containing moieties capable of accepting electrons or forming stable anions, and combinations thereof.

7. The detector array according to claim 1, wherein each organic photovoltaic cell comprises a photoactive layer, said photoactive layer comprising an electron donor material selected from the group consisting of polymers, metal oxides, metal oxides comprising a dopant, metal-phthalocyanines, and combinations thereof.

8. The detector array of claim 1, said array further comprising an emitter capable of emitting radiation, wherein the absorber is capable of absorbing the radiation emitted by the emitter.

9. A security system comprising the detector array of claim 1.

10. The security system according to claim 9, wherein the security system is an access control system.

11. (canceled)

12. A method for vein pattern recognition comprising the steps of
(a) placing an object comprising veins in proximity of a detector array according to claim 1, said detector array comprising an absorber capable of absorbing radiation;
(b) transmitting radiation through the object comprising veins to an absorber; and
(c) detecting the spatial variation in the transmitted radiation, thereby obtaining a map of the object comprising veins,
wherein the absorber is an organic photovoltaic sensor comprising an integral number of organic photovoltaic cells.

13. The method of claim 12, further comprising the step of
(d) generating from the map obtained in step (c) a vein pattern.

14. (canceled)

15. The method of claim 12, wherein in step (a) the detector array further comprises an emitter capable of emitting radiation, and in step (b) the radiation is transmitted from the emitter through the object comprising veins to the absorber.

16. A method for producing the detector array of claim 1, said method comprising the steps of
(A) producing an organic photovoltaic sensor; and
(B) integrating said organic photovoltaic sensor into a detector array.

17. The method according to claim 16, wherein in step (B) the electronic components are overlaid onto the organic photovoltaic cell or the electronic components may be applied directly to the top electrode in order to achieve the connections with individual pixels.
